(19) United States
(12) Patent Application Publication
(10) Pub. No.: US 2006/0049651 A1
(43) Pub. Date: Mar. 9, 2006

(54) Fixing device for a handle

(75) Inventors: Frederic Selvini, Falck (FR); Brice Orsy, Metz (FR)

Correspondence Address: FOLEY & LARDNER LLP, 777 EAST WISCONSIN AVENUE, SUITE 3800, MILWAUKEE, WI, 53202-5308, US

(73) Assignee: JOHNSON CONTROLS INTERIORS GMBH & CO. KG

(21) Appl. No.: 10/515,662

(22) PCT Filed: May 31, 2003
(86) PCT No.: PCT/EP03/05716

§ 371 Date: Jul. 15, 2005

(30) Foreign Application Priority Data
Jun. 17, 2002 (DE) 102 26 972.6

(51) Int. Cl. B60J 9/00

(52) U.S. Cl. 296/1.02; 296/214

(57) ABSTRACT

An attachment device for a handle within a vehicle in the vicinity of the internal face of a vehicle roof is disclosed. The device includes a base support element, which is equipped with projections that snap into cavities of a body panel and at least one locking element that locks the base support element and can be inserted into the handle. The Attachment device also includes an adapter element that can be inserted into the base support element between the handle and the body panel, for selectively coupling a handle and the roof liner with or without an airbag integrated into the latter, in the vicinity of the internal face of the vehicle roof. The adapter element is configured to receive a partial section of the locking element or elements for locking purposes.

### CROSS REFERENCE TO RELATED APPLICATIONS

The present Application claims the benefit of priority to the following International Application: PCT Patent Application No. PCT/EP03/05716 titled “Fixing Device For A Handle” filed on May 31, 2003, which claims priority to German Patent Application No. DE10226927.6 titled “Fixing Device for a Handle” filed on Jun. 17, 2002 (which are incorporated by reference herein in their entirety).

### FIELD

The invention relates to an attachment device for a handle for the passenger compartment of a motor vehicle in the region of the inside of a vehicle roof. The fixing device supports the roof lining and includes a basic carrier element of the handle, which is provided with protrusions which can be latched in cutouts of the body panel, and at least one push-in blocking element in the handle, which serves for latching the basic carrier element of the handle.

### BACKGROUND

Various attachment devices for a handle for the passenger compartment, for example, of a motor vehicle are known in practice. Typically, depending on whether the vehicle is or is not fitted with an airbag integrated in the roof lining, the attachment device may bridge different spacings. On the one hand, in the case of an application without an integrated airbag, the roof lining usually butts against the body structure, whereas, in the case of an application with an airbag integrated in the roof lining, the attachment device, as a result of the roof-lining contour curving in the direction of the interior, bridges a spacing of, for example, approximately 28 mm.

In the case of the application without an airbag integrated in the roof lining, it is generally known from practice for the attachment device, which also secures the roof lining, essentially to comprise a basic carrier element of the handle, the basic carrier element being provided with protrusions which can be latched in cutouts of the body panel. The latching of the attachment device can take place here, for example, by virtue of a blocking element, e.g. a blocking finger, which is prefitted in the basic carrier element of the handle.

In the case of the application with an airbag integrated in the roof lining, it is generally known from practice for a spacing of, for example, 28 mm, which typically arises, due to the presence of an airbag, as a result of the roof-lining contour curving in the direction of the interior, to be bridged by a different attachment element, which is suitable for fitting a handle in the region of the inside of a vehicle roof with an airbag integrated in the roof lining, this fixing element likewise bearing the roof lining at the same time.

These two different attachment devices for the application without an airbag integrated in the roof lining and the application with an airbag integrated in the roof lining are accompanied by the disadvantage that these two attachment devices usually have to be configured using different individual parts, which often requires an additional outlay from a production and an installation perspective.

One object of an embodiment of the invention is to improve or develop further the known attachment devices, while maintaining the previous advantages, so as to allow fixing of the handles for applications without an airbag integrated in the roof lining and for applications with an airbag integrated in the roof lining using the same parts for both applications. The desired attachment device here is intended to be capable of being produced straightforwardly and cost-effectively and, in addition, the desired attachment device is intended to be straightforward to handle and easy to install.

### SUMMARY

According to one embodiment of the invention, the attachment device “fixes” or attaches a handle and the roof lining, with or without an airbag integrated therein, in the region of the inside of the vehicle roof, and has an adapter element which can be inserted into a basic carrier element between the handle and the body panel. The adapter element being designed for accommodating a subregion of the blocking element for latching purposes. The adapter element thus makes it possible, by straightforward means, to allow optional fixing of the handles for applications without an airbag integrated in the roof lining and applications with an airbag integrated in the roof lining using the same parts for both applications. The fixing system for the basic carrier element on the body panel and the blocking element on the basic carrier element of the first application is transferred in each case to the adapter element of the second application so that the same parts can be used for both applications. For applications with an integrated airbag, the adapter element may be interposed such that the adapter element can be inserted into the basic carrier element between the handle and the body panel. This adapter element may be in operative connection with the basic carrier element and the blocking element by use of a latching connection so that the entire unit may be latched in the body panel. Both latching connections are secured by pushing in the blocking element.

According to an embodiment of the present invention, the basic carrier element with at least one blocking element and the basic carrier element with the adapter element inserted and at least one blocking element are designed as preassembled structural units, intended to simplify installation yet further. It is expediently possibly, for further simplification, for the basic carrier element with at least one blocking element and the basic carrier element with the adapter element inserted and at least one blocking element to be designed as structural units which are preassembled with one another and/or are prefitted on the roof lining. Furthermore, it may be provided that the adapter element is designed to be prefitted on the roof lining.

According to an alternative embodiment, the basic carrier element with at least one blocking element and the basic carrier element with the adapter element inserted and at least one blocking element are designed as separate structural units.

According to a further embodiment of the present invention, the basic carrier element of the attachment device has, on one side, a horizontally and a vertically running stop for the roof lining. The basic carrier element may have on the side of the horizontally and vertically running stops, above and adjacent to the vertically running stop, a stop notch for the body panel. It is expedient, moreover, if the basic carrier element has on the side of the horizontally and vertically running stops, in the region beneath the horizontally running stop, an aperture for accommodating a latching element of the adapter element, with a stop arranged in the region of the underside thereof. The adapter element can thus be inserted straightforwardly and securely in the basic carrier element.

According to a further embodiment, the basic carrier element has on the underside, on the side of the horizontally and vertically running stops, an aperture which runs obliquely inward in the direction of the roof lining and serves for accommodating a sheet-like reinforcing element of the handle.

Furthermore, the basic carrier element may have, in its central region, an aperture for the through-passage of the blocking element and for accommodating the same. The basic carrier element includes, on the side which is located opposite the first stop notch for the body panel in relation to the aperture for the blocking element, a second stop notch for the body panel. The basic carrier element preferably has, above the first stop notch and the second stop notch for the body panel, in each case one latching element, in particular in each case one latching nose, these two latching elements being designed such that they can be forced apart from one another. The aperture of the basic carrier element for the blocking element includes on the inside, in order to interact with this blocking element for the purpose of forcing the two latching elements apart from one another, two stop surfaces which run obliquely inward in each case and are offset in relation to one another.

The basic carrier element is also shown to include, on the side of the second stop notch for the body panel, in the region of the transverse sides of the aperture for the blocking element, apertures for accommodating two further latching elements arranged on the longitudinal sides of the adapter element.

According to a further embodiment, the basic carrier element has, on the side which is located opposite the side of the horizontally and vertically running stops, a further vertically running stop for the roof lining. The basic carrier element also includes on the opposite side, adjacent to the vertically running stop, a horizontally running stop for the body panel or for a corresponding mating stop of the adapter element inserted.

Moreover, if the basic carrier element, which may be configured in one piece, has on the opposite side, at the bottom end of the latching element located on this side, a stop nose, and if, in order to interact with this stop nose, a corresponding mating stop may be provided on the basic carrier element, beneath the inner end of the horizontally running stop.

According to a further embodiment, the basic carrier element may include on each side, in the central region of the transverse sides of the aperture for the blocking element, in each case one cutout for accommodating two latching elements arranged on the longitudinal sides of the blocking element.

According to a further embodiment of the present invention, the adapter element has, on one end side, a latching element for the through-passage through the corresponding aperture of the basic carrier element. The adapter element may include on its longitudinal sides, adjacent to its second end side, in each case one latching element for the through-passage through the apertures of the basic carrier element which are provided for this purpose. The adapter element has here on the underside, adjacent to its second end side and alongside the latching elements, a stop which mates with the horizontally running stop of the basic carrier element.

According to a further embodiment, the adapter element has on each side, at its top end region, a horizontally running stop for the body panel. In this case, the adapter element has on each side, above and adjacent to the horizontally running stops for the body panel, a stop notch for the body panel.

The adapter element may have, in its central region, an aperture for the through-passage of the blocking element and for accommodating the same, this aperture essentially comprising vertically running stop guides for the blocking element. The adapter element here preferably has, above the two stop notches for the body panel, in each case one latching element, in particular in each case one latching nose, these two latching elements being designed such that they can be forced apart from one another. The adapter element preferably includes a stop at the bottom end of the latching element located in the direction of its second end side and, in order to interact with this stop, for a corresponding mating stop to provided at the inner end of the horizontally running stop located on this side of the adapter element for the body panel.

According to a further embodiment, the latching elements of the basic carrier element and the latching elements of the adapter element are designed with essentially equal dimensions, so that production is simplified and installation is facilitated since, for example, a drillhole of the same size is provided in the body panel in each case in order for the basic carrier element and the adapter element to be fitted there.

According to a further embodiment, the blocking element has an essentially elongate configuration for through-passage through the basic carrier element alone or through the basic carrier element and the adapter element. The blocking element includes, in its bottom subregion, two mating stop surfaces for the corresponding stop surfaces of the basic carrier element, the mating stop surfaces running obliquely inward in each case and being offset in relation to one another. Furthermore, the blocking element has in its top subregion, on its inner side in the inserted state, an obliquely inwardly running mating stop in order to allow the latching element to spring back resiliently. The blocking element here is shown to include a wedge-shaped design at its top end.

According to a further embodiment, the blocking element has in its bottom subregion, on each side and located approximately centrally, in each case one latching element for engaging in the cutouts of the basic carrier element.

According to a further embodiment, the blocking element has on both sides, in the region of its stem, in each case one latching element for interacting with mating latching elements, which are formed on the basic carrier element, in the preassembled state, so that the latching elements counteract a situation where a blocking element is drawn out in the downward direction.

### BRIEF DESCRIPTION OF THE FIGURES

The invention is illustrated by way of an exemplary embodiment in the figures, in which:

FIG. 1 shows a partially cut-away sectional view of the attachment device for a handle without an adapter element and with the blocking element inserted loosely,

FIG. 2 shows the partially cut-away sectional view of the attachment device for a handle according to FIG. 1 without an adapter element and with the blocking element inserted firmly,

FIG. 3 shows a partially cut-away sectional view of the attachment device for a handle with an adapter element and with the blocking element inserted loosely,

FIG. 4 shows the partially cut-away sectional view of the attachment device for a handle according to FIG. 3 with an adapter element and with the blocking element inserted firmly,

FIG. 5 shows a schematic view, in perspective, of the attachment device for a handle without an adapter element and with the blocking element inserted firmly,

FIG. 6 shows the schematic view, in perspective, of the attachment device for a handle according to FIG. 5 without an adapter element and with the blocking element inserted loosely,

FIG. 7 shows a schematic view, in perspective, of the attachment device for a handle with an adapter element and with the blocking element inserted firmly,

FIG. 8 shows the schematic view, in perspective, of the attachment device for a handle according to FIG. 7 with an adapter element and with the blocking element inserted loosely,

FIG. 9 shows a schematic view, in perspective, of the adapter element of the attachment device for a handle,

FIG. 10 shows a schematic view, in perspective, of the basic carrier element of the attachment device for a handle, and

FIG. 11 shows a schematic view, in perspective, of the blocking element of the attachment device for a handle.

### DETAILED DESCRIPTION

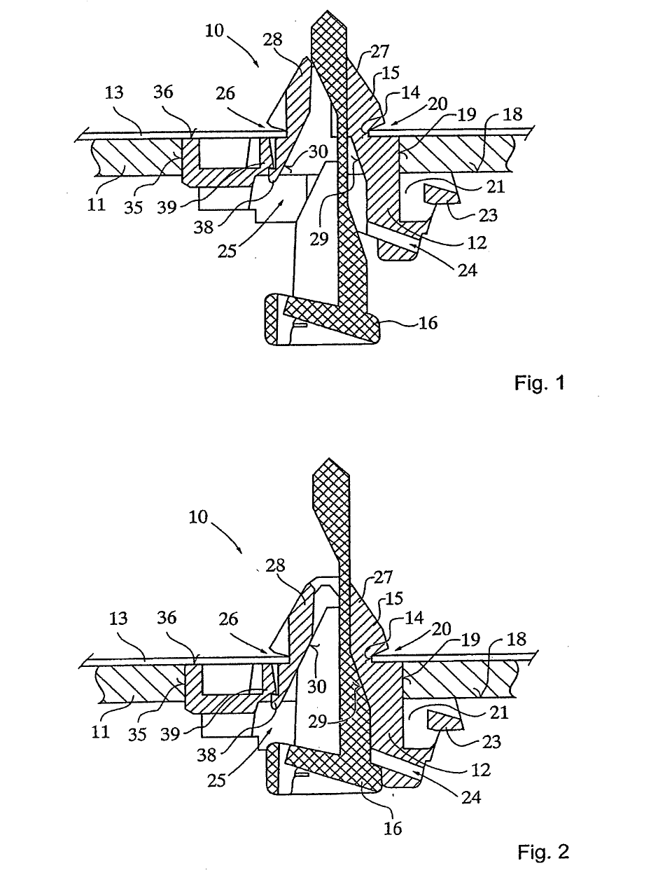

The attachment device for a handle according to the illustrated embodiments is designated in general terms by 10. The attachment device 10 is intended for use in the passenger compartment of a vehicle in the region of the inside of a vehicle roof and for also bearing the roof lining 11. The attachment device 10 (as shown for example in FIGS. 1 and 2) includes a basic carrier element of the handle 12 and is provided with protrusions 15 which can be latched in cutouts 14 of a body panel 13, and at least one push-in blocking element 16 in the handle, which serves, inter alia, for latching the basic carrier element 12 of the handle. The attachment device 10 also comprises a further attachment element for fitting a handle in the region of the inside of a vehicle roof in the case of an airbag being integrated in the roof lining 11, this attachment element also bearing the roof lining 11.

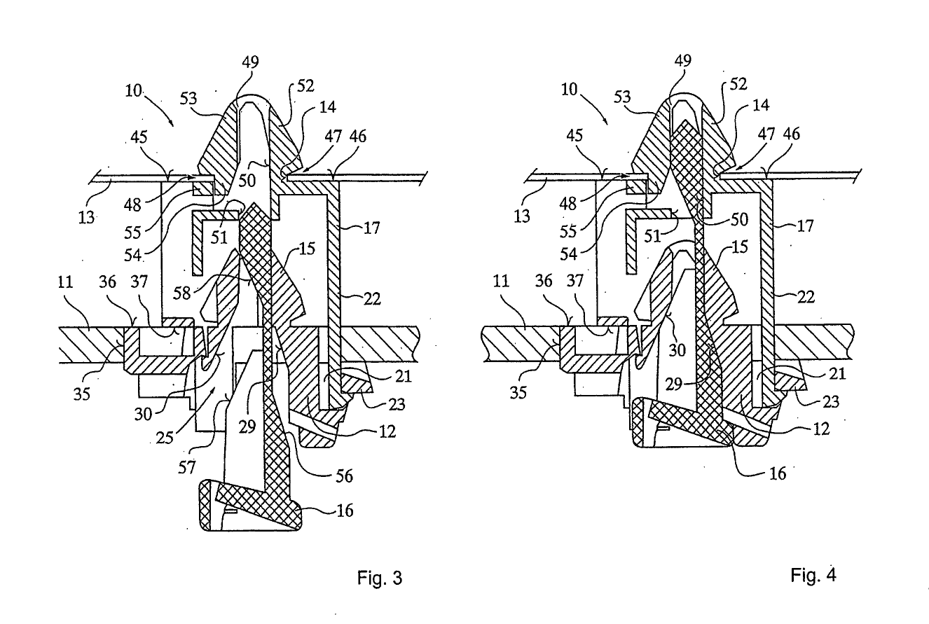

The attachment device 10 is according to one embodiment is shown in FIGS. 1 to 4 such that the attachment device 10, for fixing a handle and roof lining 11, with or without an airbag integrated therein, in the region of the inside of the vehicle roof, has an adapter element 17 which can be inserted into the basic carrier element 12 between the handle and the body panel 13. This adapter element 17 is intended for accommodating a subregion of the at least one blocking element 16 for latching purposes (see FIGS. 3 and 4 and FIGS. 7 and 8).

According to the embodiment illustrated, a first assembly including the basic carrier element 12 with the at least one blocking element 16 (see FIGS. 1 and 2) and a second assembly including the basic carrier element 12 with the adapter element 17 inserted and the at least one blocking element 16 (see FIGS. 3 and 4) are designed as preassembled structural units. This can take place, for example, in such a manner that the first assembly with the basic carrier element 12 with the at least one blocking element 16 and the second assembly with the basic carrier element 12 with the adapter element 17 inserted and the at least one blocking element 16 are designed as structural units which are preassembled with one another and/or are prefitted on the roof lining 11. Moreover, the adapter element 17 may also be designed to be prefitted on the roof lining 11. Alternatively the basic carrier element 12 and the at least one blocking element 16 and the basic carrier element 12 with the adapter element 17 inserted and the at least one blocking element 16 may be provided as separate structural units.

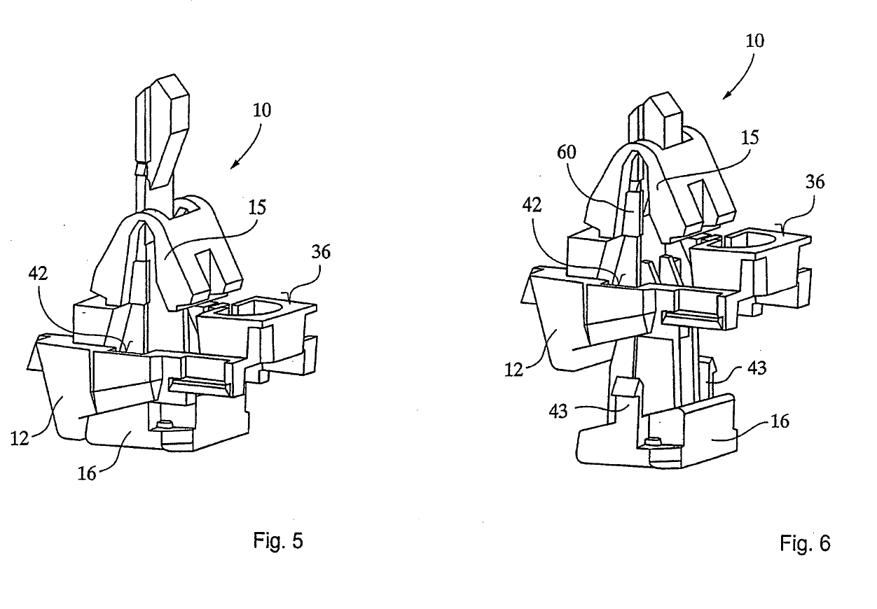

The basic carrier element 12 of the attachment device 10 according to the illustrations in FIGS. 1 and 2 and those in FIG. 5 has on one side, a horizontally and a vertically running stop 18, 19 for the roof lining 11 (as shown for example, on the right-hand side of FIG. 1). On this side of the horizontally and vertically running stops 18, 19, the basic carrier element 12 has, above and adjacent to the vertically running stop 19, a stop notch 20 for the body panel 13. On this side, the basic carrier element 12 has, in the region beneath the horizontally running stop 18, an aperture 21 for accommodating a latching element 22 of the adapter element 17, with a stop 23 arranged in the region of the underside thereof. Furthermore, the basic carrier element 12 has, on the underside of this side, an aperture 24 which runs obliquely inward in the direction of the roof lining 11 and serves for accommodating a sheet-like reinforcing element of the handle.

Referring further to FIGS. 1 and 2, the basic carrier element 12 has an aperture 25 for the through-passage of the blocking element 16 and for accommodating the same. In this case, the basic carrier element 12 has, on the side which is located opposite the first stop notch 20 for the body panel 13 in relation to the aperture 25 for the blocking element 16, a second stop notch 26 for the body panel 13. Above the first stop notch 20 and the second stop notch 26 for the body panel 13, the basic carrier element 12 has in each case one latching element 27, 28 and one latching nose, latching elements 27, 28 being designed such that they can be forced apart from one another. The aperture 25 of the basic carrier element 12 for the blocking element 16 has on the inside, in order to interact with blocking element 16 for the purpose of forcing the two latching elements 27, 28 apart from one another, two stop surfaces 29, 30 which run obliquely inward in each case and are offset in relation to one another.

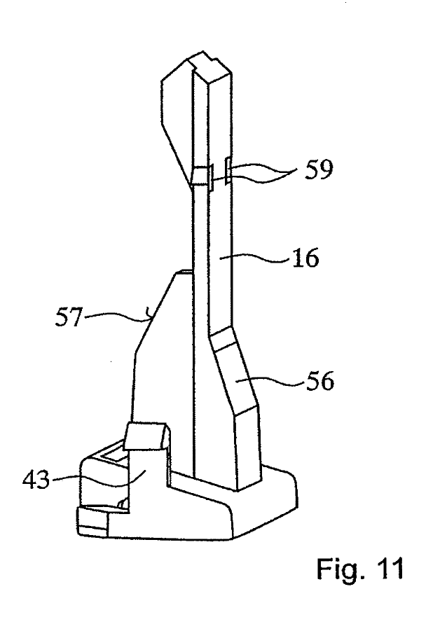

Referring to FIGS. 4, 8 and 10, basic carrier element 12 has on the side of the second stop notch 26 for the body panel 13, in the region of the transverse sides of the aperture 25 for the blocking element 16, in each case one aperture 32 for accommodating two further latching elements 33, 34 arranged on the longitudinal sides of the adapter element 17 (see also FIG. 11).

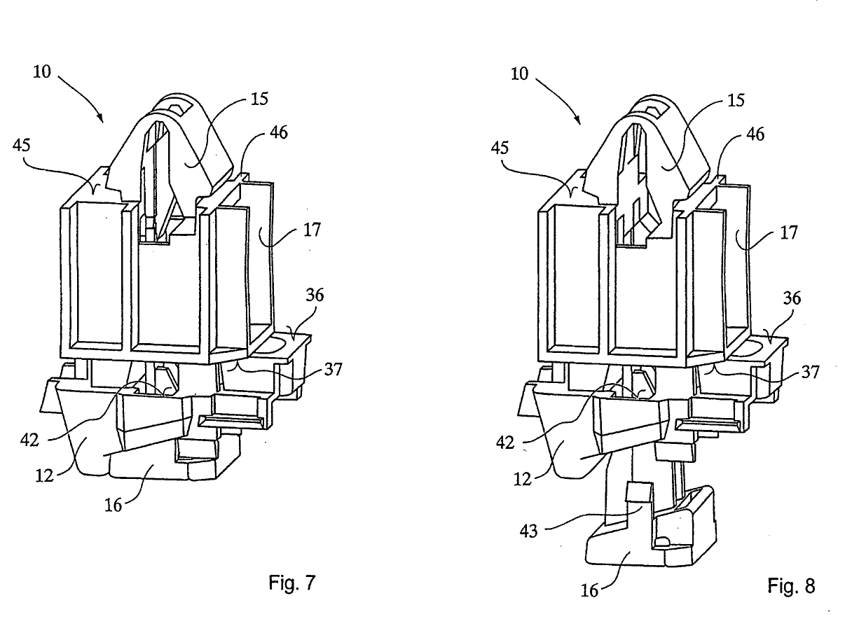

On the side which is located opposite the side of the horizontally and vertically running stops 18, 19, the basic carrier element 12 has a further vertically running stop 35 for the roof lining 11 (see FIG. 1 or 2). Adjacent to the vertically running stop 35, the basic carrier element 12 has, on this opposite side, a horizontally running stop 36 for the body panel 13 or for a corresponding mating stop 37 of the adapter element 17 inserted (see FIG. 7 or 8).

At the bottom end of the latching element 28 located on this side, the basic carrier element 12, which may be configured in one piece, has a stop nose 38 and, in order to interact with this stop nose 38, a corresponding mating stop 39 is provided on the basic carrier element 12, beneath the inner end of the horizontally running stop 36.

In the central region of the transverse sides of the aperture 25 for the blocking element 16, the basic carrier element 12 has, on each side, in each case one cutout 42 for accommodating two latching elements 43 arranged on the longitudinal sides of the blocking element 16, (see FIGS. 5 to 8 or, in relation to the latching elements 43, FIG. 11).

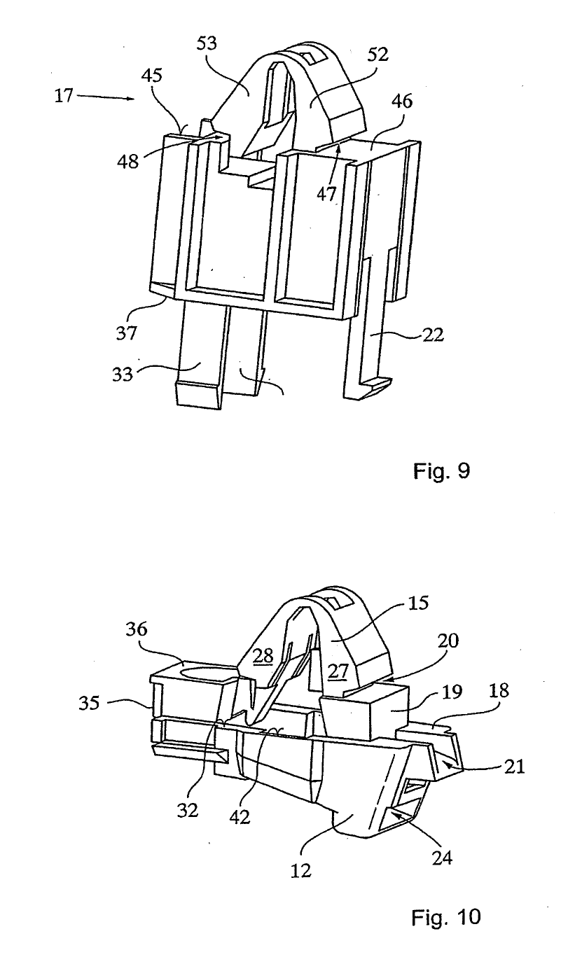

Referring to FIGS. 3-4 and 7-9, the adapter element 17 of the attachment device 10 is shown according to an embodiment. The adapter element 17 (see FIG. 9) has on one end side, a latching element 22 for the through-passage through the aperture 21 of the basic carrier element 12 (see FIG. 3 or 4). Adjacent to its second end side, the adapter element 17 has, on its longitudinal sides, in each case one latching element 33, 34 for the through-passage through the apertures 32 of the basic carrier element 12 (see FIG. 9 in conjunction with FIG. 10 and also FIG. 8). Furthermore, the adapter element 17 has on the underside, adjacent to its second end side and alongside the latching elements 33, 34, a stop 37 which mates with the horizontally running stop 36 of the basic carrier element 12. At its top end region, the adapter element 17 has, on each side, a horizontally running stop 45, 46 for the body panel 13 (see, for example, FIG. 3 or 4). Above and adjacent to the horizontally running stops 45, 46 for the body panel 13, the adapter element 17 has, on each side, a stop notch 47, 48 for the body panel 13.

In its central region, the adapter element 17 has an aperture 49 for the through-passage of the blocking element 16 and for accommodating the same, this aperture 49 comprising essentially vertically running stop guides 50 and 51 for the blocking element 16 (see FIG. 3 or 4). Above the two stop notches 47, 48 for the body panel 13, the adapter element 17 has in each case one latching element 52, 53, in this case in each case one latching nose, these two latching elements 52, 53 being designed such that they can be forced apart from one another.

The adapter element 17 (see FIG. 3 or 4), has a stop 54 at the bottom end of the latching element 53 located in the direction of its second end side and, in order to interact with this stop 54, a corresponding mating stop 55 is provided at the inner end of the horizontally running stop 46 located on this side of the adapter element 17 for the body panel 13.

According to the exemplary embodiment illustrated, the latching elements 27, 28 of the basic carrier element 12 and the latching elements 52, 53 of the adapter element 17 are designed with essentially equal dimensions. As a result, production is simplified and installation is also facilitated since, for example, a drillhole of the same size is provided in the body panel 13 in each case in order for the basic carrier element 12 and the adapter element 17 to be installed.

Referring further to FIGS. 1-4 and 11, the blocking element 16 of the attachment device 10 is shown. The blocking element 16 has an essentially elongate configuration for through-passage through the basic carrier element 12 alone or through the basic carrier element 12 and the adapter element 17. In its bottom subregion, the blocking element 16 has two mating stop surfaces 56, 57 for the stop surfaces 29, 30 of the basic carrier element 12, the mating stop surfaces running obliquely inward in each case and being offset in relation to one another (see FIG. 11). In its top subregion, the blocking element 16 has, on its inner side in the inserted state, an obliquely inwardly running mating stop 58 in order to allow the latching element 28 to spring back resiliently. At its top end, the blocking element 16 is of essentially wedge-shaped design.

In its bottom subregion, the blocking element 16 has, on each side and located approximately centrally, in each case one latching element 43 for engaging in the cutouts 42 of the basic carrier element 12. In the region of its stem, the blocking element 16 has, on both sides, in each case one latching element 59 for interacting with mating latching elements 16, which are formed on the basic carrier element 12, in the preassembled state, these latching elements 59 counteracting the situation where the blocking element is drawn out in the downward direction (see also FIG. 6).

The attachment device 10 for a handle, using the adapter element 17 makes it possible by straightforward means, to allow optional fixing of the handles for the applications without an airbag integrated in the roof lining 11 and the applications with an airbag integrated in the roof lining 11 using the same parts for both applications. The attachment system for the basic carrier element 12 on the body panel 13 and the blocking elements 16 on the basic carrier element 12 of the first application (i.e. without an airbag), is transferred in each case to the adapter element 17 of the second application (i.e. with an airbag), as a result of which the same parts can be used for both applications. Accordingly, in applications with an integrated airbag, the adapter element 17 may to be interposed such that the adapter element 17 can be inserted into the basic carrier element 12 between the handle and the body panel 13. This adapter element 17 may be in operative connection with the basic carrier element 12 and the blocking element 16 by use of a latching connection, it being possible for the entire unit to be latched in the body panel 13. Both latching devices are secured by pushing in the blocking element 16.

As has already been mentioned, the embodiments illustrated are only examples of ways of realizing the invention. The latter is not restricted thereto; rather, a number of further modifications and refinements are possible. Thus, in particular, variations in respect of the design of the adapter element 17 and of the basic carrier element 12 and also of the blocking element 16 are conceivable. Provision is also made for the invention to be used for configurations of roof linings 11 and body panels 13 which differ from the refinements illustrated.

1. An attachment device for a handle for a passenger compartment of a vehicle in a region of an inside of a vehicle roof having a roof lining, comprising: a carrier element including protrusions configured to be latched in cutouts of a body panel, and at least one blocking element configured for latching the carrier element for a coupling the handle and the roof lining to the body panel in a first configuration where the roof lining is adjacent the body panel and wherein the carrier element is configured to receive an adapter element for coupling the handle and the roof lining to the body panel in a second configuration where a space is provided between the roof lining and the body panel.

2. The attachment device of claim 1, wherein at least one of a first assembly comprising the carrier element and the at least one blocking element and a second assembly comprising the carrier element with the adapter element and the at least one blocking element is designed as a preassembled structural unit.

3. The attachment device of claim 2, wherein at least one of the first assembly and the second assembly are prefitted on the roof lining.

4. The attachment device of claim 1, wherein at least one of the first assembly and the second assembly is is designed as a separate structural unit.

5. The attachment device of claim 1 wherein the space is configured to accommodate an airbag.

6. The attachment device of claim 1 wherein the carrier element comprises a first horizontally running stop and a first vertically running stop configured to engage the roof lining.

7. The attachment device of claim 1 wherein the carrier element further comprises a first stop notch configured to engage the body panel.

8. The attachment device of claim 1 wherein the carrier element further comprises a first aperture for accommodating a first latching element of the adapter element.

9. The attachment device of claim 1 wherein the carrier element further comprises an opening which runs obliquely inward in the direction of the roof lining for accommodating a sheet-like reinforcing element of the handle.

10. The attachment device of claim 1 wherein the carrier element further comprises an aperture for the through-passage of the blocking element.

11. The attachment device of claim 7 wherein the carrier element further comprises a second stop notch configured to engage the body panel.

12. The attachment device of claim 1 wherein the protrusions of the carrier element further comprises first and second latching elements above the first stop notch and the second stop notch and configured to be forced apart from one another.

13. The attachment device of claim 10 wherein the aperture further comprises stop surfaces which run obliquely inward and are offset in relation to one another and configured to interact with the blocking element.

14. The attachment device of claim 8 wherein the carrier element further comprises at least one second aperture for accommodating at least one second latching element arranged on sides of the adapter element.

15. The attachment device of claim 6 wherein the carrier element further comprises a second vertically running stop generally opposite the first vertically running stop for engaging the roof lining.

16. The attachment device of claim 15, wherein the carrier element further comprises a second horizontally running stop adjacent to the second vertically running stop.

17. The attachment device of claim 12 wherein the carrier element further comprises a stop nose at the bottom end of the first latching element.

18. The attachment device of claim 10 wherein the carrier element further comprises cutouts on transverse sides of the aperture for the blocking element.

19. The attachment device of claim 1 wherein the adapter element has, on one end side, a first latching element for through passage through a first aperture of the carrier element.

20. The attachment device of claim 19, wherein the adapter element further comprises second latching elements for passage through the second apertures of the carrier element.

21. The attachment device of claim 20, wherein the adapter element further comprises a stop configured to engage a horizontally running stop of the carrier element.

22. The attachment device of claim 19 wherein the adapter element further comprises a horizontally running stop configured to engage the body panel.

23. The attachment device of claim 22 wherein the adapter element further comprises at least one stop notch adjacent the horizontally running stop and configured to engage the body panel.

24. The attachment device of claim 19 wherein the adapter element further comprises an aperture for the through-passage of the blocking element, the aperture comprising essentially vertically running stop guides for the blocking element.

25. The attachment device of claim 23 wherein the adapter element (17) has, above the stop notch for the body panel latching noses configured to be forced apart from one another.

26. The attachment device of claim 25 wherein the adapter element further comprises a stop at the bottom end of one of the latching noses.

27. The attachment device of claim 1 wherein the carrier element and the adapter element each comprise latching elements with essentially equal dimensions.

28. The attachment device of claim 1 wherein the blocking element has an essentially elongate configuration for through-passage through at least one of the carrier element alone or through the carrier element and the adapter element.

29. The attachment device of claim 28 wherein the blocking element has a bottom subregion comprising two stop surfaces configured to engage the carrier element, the mating stop surfaces oriented obliquely inward and offset in relation to one another.

30. The attachment device of claim 28 wherein the blocking element (16) has a top subregion with an obliquely inwardly running stop configured to allow the protrusions to spring back resiliently.

31. The attachment device claim 28 wherein the blocking element is of essentially wedge-shaped design at its top end.

32. A device for attaching a vehicle accessory to a body panel and a trim panel in the presence or absence of a space therebetween, comprising: a carrier body configured to receive the vehicle accessory and having a first latching member configured to extend at least partially through an opening in the trim panel and the body panel, and a blocking member interacting with the carrier body to engage the first latching member to the body panel so that the handle and the trim panel are attachable to the body panel in a close-fitting relationship, the carrier body further comprising a structure configured to receive an adapter member having a first portion configured to engage the trim panel and a second portion having a second latching member configured to engage the opening in the body panel and configured to interact with the blocking member to engage the second latching member to the body panel so that the handle and trim cover are attachable to the body panel in a spaced-apart relationship.

33. An attachment apparatus configured for coupling a vehicle accessory and a trim panel to a body panel within a vehicle, comprising: a carrier body attachable to the vehicle accessory and including a first stop for engaging the trim panel and a first latching member for engaging a cutout in the body panel, and a blocking member insertable within the latching member to couple the accessory and the trim panel to the body panel when the trim panel and the body panel are substantially free of a space therebetween, wherein the carrier body further comprises structure for receiving an adapter member having a second stop for engaging the trim panel and a second latching member for engaging the cutout in the body panel so that the accessory is attachable to the body panel with a space between the trim panel and body panel when the blocking member is inserted.
